(19) United States
(12) Patent Application Publication
(10) Pub. No.: US 2018/0194520 A1
(43) Pub. Date: Jul. 12, 2018

(54) VESSEL WITH ANTIMICROBIAL RIM

(71) Applicant: Charles Lovern, Buford, GA (US)

(72) Inventor: Charles Lovern, Buford, GA (US)

(21) Appl. No.: 15/855,678

(22) Filed: Dec. 27, 2017

Related U.S. Application Data
(60) Provisional application No. 62/444,348, filed on Jan. 9, 2017.

(51) Int. Cl. B65D 25/20; A01N 59/20; A47G 19/22

(52) U.S. Cl. CPC B65D 25/20; A47G 2400/022; A47G 19/2205; A01N 59/20

(57) ABSTRACT

A beverage vessel having an antimicrobial rim is presented. Preferably, the rim comprises copper and the body of the vessel is composed of a different material than the rim. The antimicrobial rim kills microbes that come in contact with it from the ambient environment of from a user. The rim can be permanently disposed at the vessel or can be removably disposed.

This application claims priority from U.S. Provisional Application No. 62/444,348, to Lovern, titled “Vessel with Antimicrobial Rim” filed on Jan. 9, 2017, which is herein incorporated in its entirety by reference.

### FIELD OF INVENTION

This invention relates generally to beverage containers, and more particularly to beverage containers comprising a metallic antimicrobial rim.

### BACKGROUND OF INVENTION

Over recent decades, the general public has shared an increased awareness and interest in taking proactive steps towards preventing disease and improving both individual and public health. New classes of pharmaceuticals and vaccines that combat diseases have been developed and marketed. However, these disease fighting agents have their disadvantages and limitations. For example, in the case of pharmaceuticals, most are designed to be administered after a person has already contracted a disease and is exhibiting symptoms. In general, medications are generally not used to protect a person against becoming ill in the first place. Pharmaceutical products may treat the symptoms, and may arrest further development of the disease, but a person who purchases a prescribed or over-the-counter medicine is typically already infected with a virus or bacteria and is experiencing its effects and discomfort. In addition, once administered, drugs can cause discomfort because many have an unpleasant taste or can cause undesired side effects such as short-term drowsiness, dizziness stomach distress, allergic reactions, etc., or long term adverse effects such as stress on a patient's liver.

In addition, administration of pharmaceuticals can have significant effects on public health as a whole, particularly when they are overused or misused. For example, while antibiotic drugs have saved countless patients from life-threatening infections, the misuse of the same drugs has led to the development of antibiotic resistant bacteria that pose a serious health risk to the population at large. A particular antibiotic is developed to target a particular bacterium species, and will be ineffective against other bacteria strains. When bacteria are attacked by a particular antibiotic drug, they can protect themselves by passively modifying themselves, or by aggressively neutralizing the antibiotic. This can happen because the drug cannot spontaneously kill all the bacteria in a patient with one dose, but must act over a period of time of multiple doses. Because the bacteria have the ability and time to defend themselves, typically through DNA modifications, the antibiotic drug can lose its effectiveness against the infecting bacteria. Bacteria that have changed to become antibiotic resistant can multiply and pass on that resistance to their progeny, and in some cases they can even transfer that resistance to other non-progeny bacteria in their environment. Accordingly, some infections that used to be fairly easy to treat with antibiotics have become more difficult to treat. This phenomenon is exacerbated when antibiotics are prescribed, often at a patient's request, for illnesses caused by viruses that are not even treatable with an antibiotic, such as colds, flu, most sore throats and coughs, and the stomach flu. As a result, there are several strains of bacteria today that cannot be destroyed with an antibiotic drug. While vaccines are pro-active and are used to prevent a person from contracting a particular disease and suffering its symptoms, vaccines are not one hundred per cent effective. A vaccinated person's immunity may decrease over time, making him or her vulnerable when exposed to the disease. Alternatively, in the case of the flu vaccine, vaccine producers must predict which flu strains will dominate an upcoming flu season, and develop a vaccine targeting those strains. The vaccine will be useless against other non-targeted influenza viruses, thus an inoculated person may still succumb to the flu. A further disadvantage of vaccines is that in some cases, inoculated patients actually experience a case of the disease that they have been vaccinated against, and thus experience the symptoms that they had attempted to avoid. Finally there remain many contagious illnesses for which there are presently no vaccines. Thus, it is easy to see that while pro-active, vaccines cannot fully protect against the spread of germs and disease.

Non-medicinal products have also been developed for preventing and combating disease. A class of products that has exploded in popularity over the past 10-20 years is that of antibacterial products, in the form of hand soaps, body soaps, dishwashing soaps, other hygiene products, various cleansers, etc. These products include substances that can kill bacteria. While certainly having become ubiquitous, easily accessible and generally affordable, these types of products are generally effective only when one is in the process of using them. For example, washing one's hands with an anti-bacterial soap kills the bacteria present on the hands while they are being washed. After the hands have been rinsed and dried, i.e. after the anti-bacterial soap is removed, newly contacted microbes will be unaffected until the hands are washed again. The antimicrobial effect of the soap is temporary and fleeting. In addition, like the overuse antibiotic drugs, the widespread use of antibiotic non-medicinal products can also lead to bacteria adapting to become antibiotic resistant, contributing to a significant threat to public health.

What is needed is an accessible, non-intrusive, affordable means of preventing and combating disease that offers long-lasting disease-fighting effects without requiring medical intervention, without inflicting undesired side effects, and without promoting the development of antibiotic resistant bacteria.

### SUMMARY OF THE INVENTION

In an example embodiment, the present invention provides a beverage container or vessel that has an antimicrobial rim at its mouth. An example container has a body for accommodating a fluid beverage; the body having a base at a first bottom end to support the body, and a sidewall circumferentially around the base that defines the shape and bounds of the body. At its top opposing end, an example body has a mouth having an antimicrobial rim configured to kill microbes and pathogens that cause human infection. By way of example, the rim can comprise copper, a substance that can destroy microbes on contact. An antimicrobial rim can be deposited at the body as a flat metallic layer that can be deposited on both internal and external surfaces of the body. In an alternative embodiment, an antimicrobial rim can be in the form of a rolled lip disposed at the top of the body. An antimicrobial rim can be fixed to the body, for example a container can have a plated copper alloy rim deposited on the body that is to remain permanently. Alternatively, a beverage container can have a removable rim that is manufactured separately from the body and can be releasably positioned at the body's mouth. The copper alloy rim kills microbes that contact it so that a user can safely drink from the cup without exposure to pathogens that may exist in the user's environment.

### BRIEF DESCRIPTION OF THE DRAWINGS

FIG. 1 shows an example beverage vessel having an antimicrobial rim.

FIG. 2A shows an example embodiment having a flat rim.

FIG. 2B shows an example embodiment having a rolled rim.

FIG. 3A shows an example vessel and flat removable rim.

FIG. 3B shows an example rolled removable rim.

FIG. 4 shows variably sized vessels, with and without detachable lids, having a copper rim.

### DETAILED DESCRIPTION OF EXAMPLE EMBODIMENTS

Example embodiments of the invention are presented herein; however, the invention may be embodied in a variety of alternative forms, as will be apparent to those skilled in the art. To facilitate understanding of the invention, and provide a basis for the claims, various figures are included in the specification. The figures are not drawn to scale and related elements may be omitted so as to emphasize the novel features of the invention. Structural and functional details depicted in the figures are provided for the purpose of teaching the practice of the invention to those skilled in the art and are not to be interpreted as limitations. For discussion purposes, unless a specific reference is made to pure copper the terms “copper” and “copper alloys” are generally interchangeable as substances having antimicrobial properties since they both comprise copper.

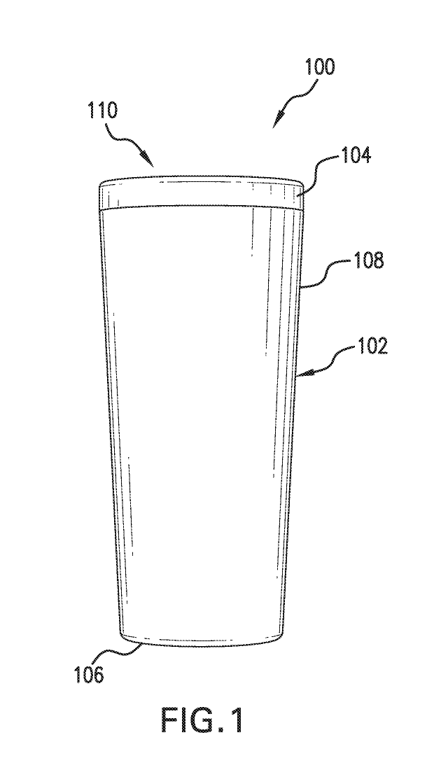

FIG. 1 shows an example vessel 100 having a body 102 and antimicrobial rim 104. The body 102 has a base 106, a sidewall 108 disposed circumferentially at said base, and a mouth 110 configured to receive a fluid. In an example embodiment, the vessel 100 is embodied as drinkware for a consumer. The antimicrobial rim 104 can comprise any substance having antimicrobial properties enabling it to kill microbes or impede their growth and multiplication. The rim 104 protects a user by destroying microbes that come in contact with the rim so that a user can drink from the vessel without consuming microbes or bacteria present in the user's environment that may have come in contact with the vessel.

In an exemplary embodiment, the rim 104 comprises copper. It can be composed of pure copper or a copper alloy. Copper can be combined with a wide variety of other elements in various combinations to provide a variety of alloys such as, but not limited to, brass, which is a combination of copper and zinc, and bronze which is an alloy of copper and tin. While both alloys contain copper, their physical appearances are different; with brass having a shiny appearance that makes it attractive for forming decorative home accents, and bronze having a duller more matte finish that is nevertheless also used for ornamental work. While the outward appearances and colors of the various copper alloys may vary, their common copper component causes them to share some common material characteristics.

One common characteristic shared by many copper alloys is the ability to kill a variety of microorganisms on contact. Various scientific studies have proven the effectiveness of copper surfaces to destroy or impede microbial growth. For example, the February 2011 issue of the journal Applied and Environmental Microbiology published a paper by Gregor Grass of the University of Nebraska reporting that metallic copper surfaces kill microbes within minutes of contact. The copper surface was so effective at destroying the bacteria that the author concluded that virtually no live microorganisms could be recovered from the surface after about a minute of exposure. An inexhaustive list of the microbes that can be killed by copper include:
Escherichia coli, a foodborne organism associated with food recalls;
Methicillin-resistant staphylococcus aureus (MRSA) an antibiotic resistant bacteria;
Staphylococcus aureus, a bacteria that can cause pneumonia and meningitis;
Enterobacter aerogenes, a bacterium commonly found in hospitals;
Pseudomonas aeruginosa, a microorganism that can attack people with compromised immune systems; and
Vancomycin-resistant Enterococcus (VRE), the second leading cause of infections in hospitals.

Copper has proved to be such an effective microbial agent that the EPA has registered several copper alloys that can be advertised as having specific antimicrobial properties. The alloys can be categorized by the percentage of copper they contain as listed below:

| Group | Copper % | EPA Registration Number |
|---|---|---|
| I | 95.2 to 99.99 | 82012-1 |
| II | 87.3 to 95.0 | 82012-2 |
| III | 78.1 to 87.09 | 82012-3 |
| IV | 68.2 to 77.5 | 82012-4 |
| V | 65.0 to 67.8 | 82012-5 |
| VI | 60.0 to 64.5 | 82012-6 |

While having varying percentages of copper, all the alloys have demonstrated effectiveness in killing and inhibiting various types of bacteria.

In addition, research indicates that the copper surfaces are not destroying the bacterial organisms by damaging their DNA, but rather by causing severe and catastrophic damage to the microorganism's membranes. Other antibacterial products, such as the antibiotic drugs and non-medicinal products such as antibacterial soaps discussed previously herein, killed bacteria but also triggered genetic mutations that led to the bacteria becoming resistant to the products. The mutations not only reduce the future effectiveness of the products, but also end up potentially harming the general population by promoting the development and spread of antibiotic resistant bacteria. By contrast, copper does not trigger genetic mutations, making it a safer and more effective means of protecting both the individual user and the general public at large. As an added advantage, copper surfaces exude a “halo effect” that inhibits bacterial growth on proximate non-copper surfaces. Hospital research has shown that copper surfaces can reduce bacterial colonies on non-copper surfaces up to 50 cm away. Accordingly, when comprising copper, the antimicrobial rim 104 can exhibit a halo effect on the vessel body 102, killing microbes that may be deposited there by the user's hands or through vessel 100 contact with the environment.

A further advantage of using copper is that its density improves the insulation of a vessel by helping prevent ultraviolet (UV) radiation penetration of the vessel which can heat up cold beverages stored therein.

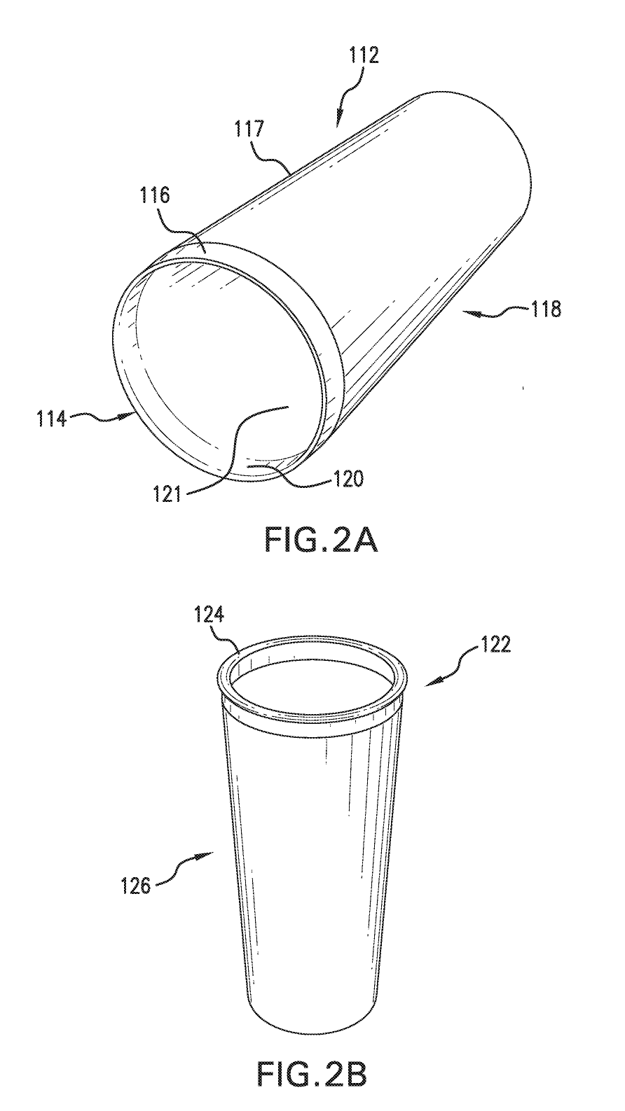

A vessel with an antimicrobial rim can be variably embodied. For example, referring to FIG. 2A, the example vessel 112 can be configured with a flat rim 114 having an exterior portion 116 disposed at an exterior surface 117 of the body 118, that includes the upper edge that defines the vessel mouth. By way of example, but not limitation, the flat rim 114 can also have an interior portion 120 disposed at an interior surface 121 of the body 118, connected to the exterior portion 116 by a portion disposed at the upper edge of the body 118. Having both interior and exterior portions improves the ability of the vessel 112 to protect a user by killing microbes that contact the rim 114 on both the interior and the exterior of the vessel. The rim 114 can be sized to cover an area on the vessel that would typically come in contact with a drinker's mouth. By way of example, but not limitation, the rim 114 can have a width ranging from around one-half inch to one inch.

FIG. 2B depicts an alternative embodiment 122 having a rolled rim 124 that covers the top edge of the vessel body 126, again having rim portions at internal and external surfaces of the vessel 122. The rim 124 can be sized to cover an area on the vessel that would typically come in contact with a drinker's mouth with a rim lip height that is comfortable for an average consumer. Other styles, shapes and sizes of rims will occur to those skilled in the art.

As will be readily apparent to those skilled in the art, there are various methods that can be employed to provide an antimicrobial rim, such as the rim 114, to the vessel body 118. By way of illustrative example, but not limitation, a copper rim can be provided to the vessel body 102 through an electrochemical process such as electrolytic plating, also referred to as electroplating, or, in the case of depositing copper, referred to as copper plating. In an example embodiment, brush electroplating can be performed to provide the copper rim in a particular localized area at a vessel. For the purposes of the plating process, the vessel body 118 is considered a substrate on which the copper rim 114 is an auxiliary deposit. In a preferred embodiment, the body 118 of the vessel 112 has a composition that is distinctly different from the copper rim 114. For example, the vessel body 118 can comprise stainless steel, an alloy of steel and chromium, while the rim 114 comprises pure copper or a copper alloy having an elemental composition that is different from that of stainless steel. Stainless steel is a particularly attractive material for the vessel body 118 when the rim 114 comprises a plated rim as it is readily conducive to the plating process.

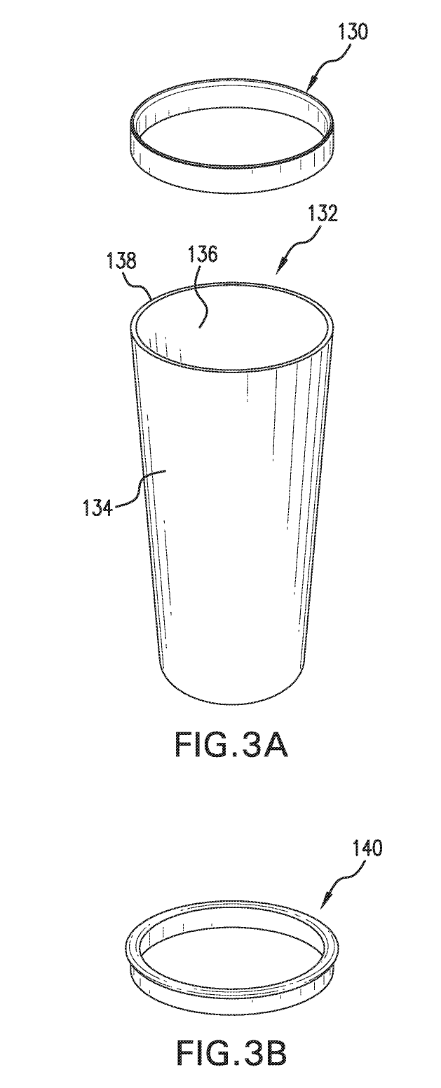

A plated rim as described above is a rim permanently affixed to a vessel body. In an alternative embodiment, an antimicrobial rim can be configured to be releasably attached to a vessel body. FIG. 3A shows an example removable rim 130 that can be provided to a rimless vessel 132. The rim 130 can comprise copper and can be manufactured separately from the vessel 132. The rim 130 can be relatively thin or flat and configured to friction fit the top of the vessel 132. By way of example, the rim 130 can be configured to fit around the circumference of the outer surface 134 of the vessel 132. In an exemplary embodiment, the rim 130 can have a first portion that contacts the outer surface 134 and vessel upper edge and a second portion that contacts the inner surface 136 of the vessel 132. FIG. 3B shows a further embodiment 140 which is a removable rim manufactured separately and is in the form of a rolled rim. Again, various styles and sizes of removable rims will occur to those skilled in the art. The example removable rims 130 and 140 can comprise copper or a copper alloy and can be configured to friction fit the vessel 132, or otherwise removably attach thereto. Removable copper rims can be variably sized to fit a variety of vessel or container diameters. It is contemplated that a particular size rim can be used for vessels of multiple sizes that share a common mouth diameter. For example, 8 oz, 12 oz. and 16 oz. vessels may all have the same mouth diameter so a rim of that diameter could be received at any of the vessels.

Using a removable rim that is manufactured separately increases the types of materials that can be used to manufacture the vessels. A vessel of practically any composition can be configured to receive a releasably coupled non-permanent copper rim. As will be known by those skilled in the art, standard methods of manufacturing copper products can be used to manufacture a stand-alone copper rim that can be provided to a vessel.

Thus the invention provides a vessel having an antimicrobial rim that kills various microorganisms on contact. In a preferred embodiment, a rim and vessel body have different compositions, with the rim comprising some non-zero amount of copper that is sufficient to provide antimicrobial properties. In an exemplary embodiment, the rim comprises an alloy registered with the EPA as discussed previously herein. A vessel can be configured with a permanent non-removable rim, such as that deposited by electroplating techniques, or with a releasable rim that can be provided to the vessel body and then subsequently removed by a user. While the copper is most effective at killing microbial organisms when it is dry, a rim that gets wet by a person drinking a beverage contained therein, will quickly dry and resume its antimicrobial effects. Copper has been shown to be wear resistant and able to withstand harsh chemicals. Accordingly, it is expected that a rim that is deposited by a plating technique or other method intended to deposit a permanent non-removable rim, will indeed be permanent and will not erode under common use. Therefore a vessel having a copper rim is expected to retain its germ-killing characteristics over its entire lifetime.

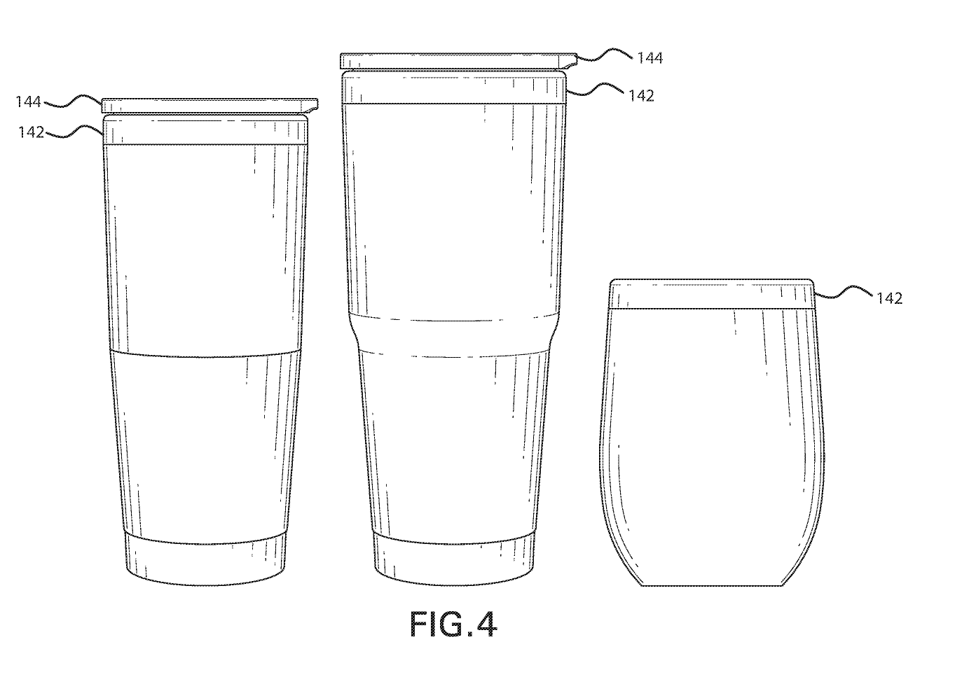

A wide variety of vessels, configured to hold hot or cold fluids, can be configured with the copper antimicrobial rim, such as stainless steel water bottles, insulated tumblers, glass bottles, glass drinkware, etc., with the list of possibilities practically endless if a removable rim is used. FIG. 4 shows some examples of variably sized vessels. As can be seen from FIG. 4, a copper rim does not impede use of a top or lid for a vessel. A vessel having a copper rim 142 as described herein can be equipped with a lid 144, such as a spill-proof lid for those desiring a travel mug or the like. The antimicrobial rim 142 can kill microbes from the user's environment that contact it, and can also kill microbes deposited by a user from the user himself. It is particularly useful in public environments in which a large number of people are gathered and a person's exposure to germs is increased. The halo effect of the copper can destroy microbes at the vessel body other than at the rim.

A vessel with a copper rim can be easily maintained, there is no special care required other than regular cleaning. In a preferred embodiment, a copper alloy can be used that resists oxidizing and tarnishing so that an attractive appearance can be maintained over the life of the vessel. A copper-rimmed vessel provides a safe economical way to prevent disease without causing undesired side effects to an individual or to the public at large.

While discussed herein in the context of a vessel having a copper antimicrobial rim, it is contemplated that a vessel can also have other antimicrobial portions comprising copper, a copper alloy or other antimicrobial substance. For example, a copper handle to destroy bacteria on the handle that could contact user's hand, a copper bottom to destroy bacteria that come in contact with a vessel's base that could potentially spread to the body of the cup and the user's hand, etc.

As required, illustrative embodiments have been disclosed herein, however the invention is not limited to the described embodiments. As will be appreciated by those skilled in the art, aspects of the invention can be variously embodied, for example, modules and programs described herein can be combined, rearranged and variously configured. Methods are not limited to the particular sequence described herein and may add, delete or combine various steps or operations. The invention encompasses all systems, apparatus and methods within the scope of the appended claims.

1-20. (canceled)

21. A vessel with enhanced antimicrobial properties, comprising:
a body that accommodates a fluid, said body having a base, a circumferential sidewall defining said vessel shape and dimension, and a mouth for receiving said fluid;
an auxiliary antimicrobial rim provided to a surface of said body to increase antimicrobial effect of said vessel, said rim composition having greater antimicrobial capability than said body composition.

22. The vessel of claim 21, wherein said rim composition has a greater percentage of copper than said body composition.

23. The vessel of claim 21, wherein said rim comprises a deposit of antimicrobial metal.

24. The vessel of claim 21, wherein said rim is releasably attached to said vessel.

25. The vessel of claim 21, wherein said rim is fixed at said vessel.

26. The vessel of claim 21, wherein said body comprises stainless steel.

27. A vessel with enhanced antimicrobial properties, comprising:
a body configured to receive and accommodate a fluid;
an antimicrobial auxiliary component attached to said body, said auxiliary component comprising a greater percentage of copper than said body.

28. The vessel of claim 27, wherein said auxiliary component is releasably attached to said body.

29. The vessel of claim 27, wherein said auxiliary component is fixed to said body.

30. The vessel of claim 27, wherein said auxiliary component comprises copper plating deposited on an exterior surface of said body.

31. The vessel of claim 27, wherein said body is copper-free.

32. The vessel of claim 27, wherein said body comprises stainless steel.

33. The vessel of claim 27, wherein said auxiliary portion is a handle.

34. The vessel of claim 27, wherein said auxiliary portion is a rim for said vessel.

35. The vessel of claim 27, wherein said auxiliary portion is a base for said vessel.

36. An antimicrobial accessory for a vessel, comprising:
a stand-alone rim comprising antimicrobial material, said rim configured to attach to said beverage vessel to provide antimicrobial capability to said vessel.

37. The rim of claim 36,wherein said rim comprises copper.

38. The rim of claim 36, wherein said rim is configured to fit around a mouth of said vessel.

39. The rim of claim 36, wherein said rim is releasably attached to said vessel.

40. The rim of claim 36, wherein said rim comprises a metal other than copper.
